(19) United States
(12) Patent Application Publication
(10) Pub. No.: US 2009/0213613 A1
(43) Pub. Date: Aug. 27, 2009

(54) Vehicle Headlight

(75) Inventors: Gerhard Mitic, München (DE); Siegfried Ramminger, München (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft mit beschrankter Haftung, Munich (DE)

(21) Appl. No.: 12/278,086

(22) PCT Filed: Jan. 31, 2007
(86) PCT No.: PCT/DE2007/000180

§ 371 Date: Apr. 5, 2009

(30) Foreign Application Priority Data
Feb. 1, 2006 (DE) 10 2006 004 593.9
Mar. 9, 2006 (DE) 10 2006 010 977.5

(51) Int. Cl. B60Q 1/00

(52) U.S. Cl. 362/547

(57) ABSTRACT

A motor vehicle headlight comprising an illuminating device (3) which comprises at least one light-emitting diode chip (20). The motor vehicle headlight furthermore has a heat pipe (5) or a thermosiphon (35) with an evaporation region (6) and a condensation region (7), wherein the evaporation region (6) is thermally connected to the illuminating device (3), and the condensation region (7) is connected to a heat sink (8) which outputs heat absorbed at the illuminating device (3) to the surrounding area.

The present patent application claims the priority of the German patent application 102006004593.9 and the priority of the German patent application 102006010977.5, the disclosure content of which is hereby incorporated by reference.

The document U.S. Pat. No. 6,601,982 describes a motor vehicle headlight.

An object to be achieved is that of specifying a motor vehicle headlight with improved heat management.

According to at least one embodiment, the motor vehicle headlight has an illuminating device which comprises at least one light-emitting diode chip. The illuminating device preferably comprises a large number of light-emitting diode chips. The illuminating device forms a light source of the headlight.

According to at least one embodiment of the motor vehicle headlight, the headlight comprises a heat pipe or a thermosiphon. The heat pipe or the thermosiphon has an evaporation region. In the evaporation region, the heat pipe or the thermosiphon absorbs heat.

Furthermore, the heat pipe or the thermosiphon has a condensation region. In the condensation region, the heat pipe or the thermosiphon outputs some of the heat absorbed in the evaporation region to the surrounding area.

According to at least one embodiment of the motor vehicle headlight, the evaporation region is thermally coupled to the illuminating device, i.e. the heat pipe or the thermosiphon absorbs, in the evaporation region, at least some of the heat generated by the illuminating device during operation. The absorbed waste heat is guided by the heat pipe or the thermosiphon to the condensation region of the heat pipe or the thermosiphon.

According to at least one embodiment of the motor vehicle headlight, the condensation region of the heat pipe or of the thermosiphon is connected to a heat sink. The heat sink is preferably connected in a mechanically fixed manner to the heat pipe or the thermosiphon. It is connected to the heat pipe or the thermosiphon, for example, by soldering or clamping. It is, however, also possible for the heat sink to be designed in one piece with the heat pipe or the thermosiphon. This means that the heat sink can be an integral part of a pipe of the heat pipe or of the thermosiphon, for example. Heat sink and pipe are in that case connected to one another without an interface and can be produced, for example, together in a single work step. The heat sink outputs at least some of the heat absorbed at the illuminating device to the surrounding area.

According to at least one embodiment of the motor vehicle headlight, the motor vehicle headlight has an illuminating device which comprises at least one light-emitting diode chip. The motor vehicle headlight furthermore comprises a heat pipe or a thermosiphon. The heat pipe or the thermosiphon comprises an evaporation region and a condensation region. Here, the evaporation region is thermally connected to the illuminating device. The condensation region is connected to a heat sink. The heat sink preferably outputs heat absorbed at the illuminating device to the surrounding area.

The motor vehicle headlight described herein takes advantage, inter alia, of the knowledge that a motor vehicle headlight has regions with widely different temperatures, i.e. a large temperature gradient can arise in the motor vehicle headlight. If the temperature gradient is large, the use of heat pipes or thermosiphons for transporting heat proves particularly efficient. For example, temperatures of up to 150° Celsius can occur in the region of the illuminating device due to the waste heat of the engine and of the illuminating device. The temperature at the cover plate of the headlight, through which cover plate the light produced by the illuminating device leaves the headlight, lies in the range of the external temperature. The heat can thus be transported from the illuminating device to the cover plate particularly efficiently.

According to at least one embodiment of the motor vehicle headlight, the heat sink has at least one cooling structure. The cooling structure of the heat sink can, for example, be provided by a comb-type surface of the heat sink. Alternatively, or additionally, it is possible for the heat sink to comprise cooling fins or cooling plates. Overall, the cooling structure is suitable for increasing the surface area of the heat sink. This enables a particularly efficient dissipation of heat to the area surrounding the heat sink. The heat sink preferably contains or consists of a material which conducts heat well, such as a metal. The heat sink can, in addition, contain copper and/or aluminum or consist of either of these metals, for example.

According to at least one embodiment, the evaporation region of the heat pipe or of the thermosiphon is thermally connected to the underside of the illuminating device, which underside faces away from the main emission direction of the light-emitting diode chip. The illuminating device can additionally comprise, for example, a connection mount on which the light-emitting diode chip is mounted. The main emission direction of the light-emitting diode chip is then directed away from the connection mount. The evaporation region of the heat pipe or of the thermosiphon can be connected directly to the underside of the illuminating device.

Here, the motor vehicle headlight described herein takes advantage, inter alia, of the knowledge that light-emitting diode chips have a maximum operating temperature of 150° Celsius and therefore only a small fraction—as compared to, for example, the heat transport using heat conductance—of the lost heat is output to the surrounding area by means of heat emission. A large fraction of the heat is output to the connection mount for the light-emitting diode chips by means of heat conductance. It therefore proves to be particularly efficient to absorb heat at the connection mount and dissipate it from there.

According to at least one embodiment, the evaporation region of the heat pipe or of the thermosiphon is connected to a heat conducting element. The heat conducting element may be, for example, a plate which consists of a material which conducts heat particularly well, such as copper and/or aluminum, or contains either of these materials. The heat conducting element can furthermore be formed from a heat-conductive composite such as AlSiC, CuSiC or Al-diamond. The heat conducting element is preferably thermally connected and/or coupled to the illuminating device. In addition, the heat conducting element can be connected to the underside of the illuminating device, for example mechanically—for example using a solder connection.

By way of example, in the case of a thermosiphon, the evaporation region can be present in the form of a basebody. The basebody then forms the heat conducting element to which a pipe loop—in the case of a loop thermosiphon—or a simple pipe—in the case of a thermosiphon—is tied. The heat conducting element and thermosiphon are thus designed in one piece.

The illuminating device can, for example, be connected to the heat conducting element in a thermally conducting manner by means of soldering or clamping with heat conducting paste.

According to at least one embodiment of the motor vehicle headlight, the heat sink outputs at least some of the heat absorbed at the illuminating device to the cover plate of the motor vehicle headlight. The cover plate of the motor vehicle headlight is here formed from a material which is transparent at least for a large portion of the electromagnetic radiation produced by the light-emitting diode chip. By way of example, the cover plate consists of a glass. The electromagnetic radiation produced by the illuminating device during operation leaves the motor vehicle headlight by way of the cover plate.

The heat sink can, for example, be in direct contact with the cover plate. However, it is also possible for the heat sink to be arranged in the direct vicinity of the cover plate of the headlight, with the result that there is a gap between heat sink and cover plate, which is preferably filled with air. The heat is dissipated from the heat sink by way of heat conductance and/or convection. The heat sink is preferably arranged on the underside of the cover plate, which underside faces the vehicle underside. In this manner, the heat which rises on account of free convection—i.e. heated air, for example—can be distributed over the entire cover plate.

It is, however, also possible for the heat sink to be arranged on the upper side of the cover plate. Although this results in less expedient conditions for the free convection of heat as compared to the arrangement on the underside, the heat transport of the heat pipe or of the thermosiphon improves, since gravity assists the back-transport of the condensate in the cooling cycle.

According to at least one embodiment of the motor vehicle headlight, the heat sink extends over at least 50% of the length of the cover plate. The heat sink preferably extends over at least 75% of the length of the cover plate of the motor vehicle headlight.

This makes it possible for the heat output by the heat sink to be able to be distributed over the entire cover plate of the headlight in a particularly uniform manner. This allows, for example, a particularly quick de-icing of a large area of an iced-up cover plate. At least some of the heat output by the illuminating device during operation can be used in this manner particularly efficiently for heating and/or de-icing the cover plate.

The motor vehicle headlight described herein will be explained in more detail below with reference to exemplary embodiments and to the associated figures, in which

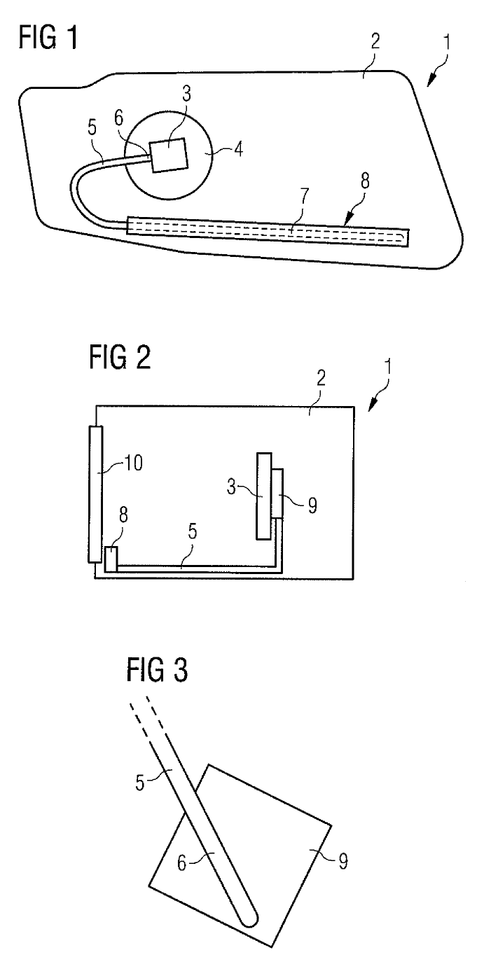

FIG. 1 shows a schematic front view of a motor vehicle headlight according to a first exemplary embodiment of the motor vehicle headlight,

FIG. 2 shows a schematic side view of a motor vehicle headlight according to a second exemplary embodiment of the motor vehicle headlight,

FIG. 3 shows a schematic detail representation of a part of a heat pipe according to an exemplary embodiment of the motor vehicle headlight,

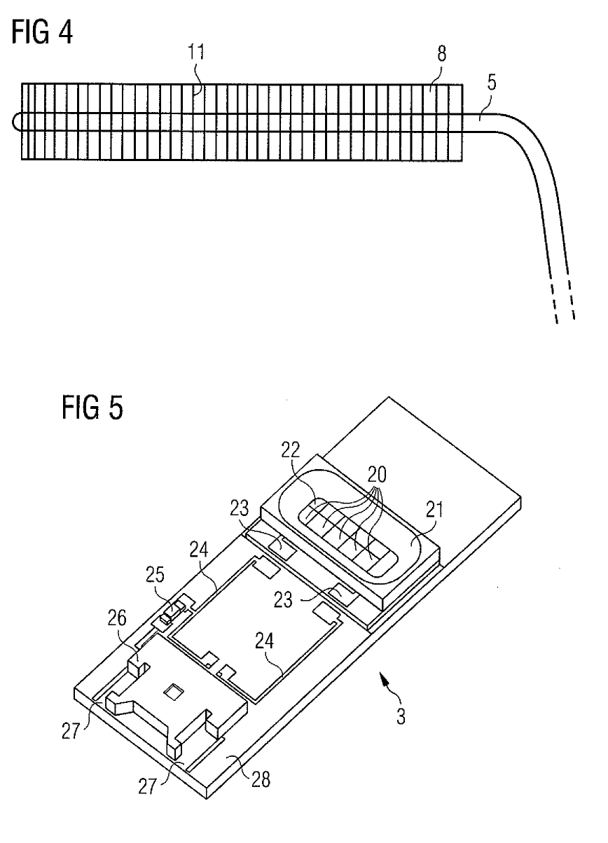

FIG. 4 shows a schematic detail representation of a part of a heat pipe with heat sink according to an exemplary embodiment of the motor vehicle headlight,

FIG. 5 shows a schematic perspective representation of an illuminating device according to an exemplary embodiment of the motor vehicle headlight, and

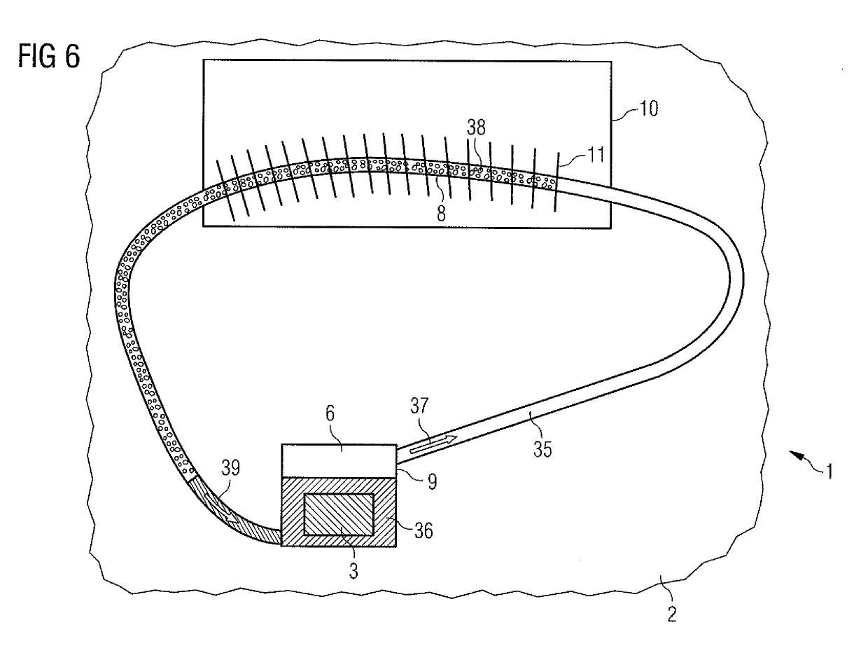

FIG. 6 shows a principle schematic of a motor vehicle headlight according to a third exemplary embodiment of the motor vehicle headlight.

In the exemplary embodiments and figures, identical or identically acting components in each case have identical reference numerals. The illustrated components and the scale ratios of the components with respect to one another are not to be considered as being to scale. Rather, the size of some of the details illustrated in the figures is, for the sake of improved understanding, exaggerated.

FIG. 1 shows a motor vehicle headlight described herein according to a first exemplary embodiment in a schematic front view. The motor vehicle headlight 1 comprises a headlight housing 2. The headlight housing 2 can be formed, for example, by part of the body of a motor vehicle.

The motor vehicle headlight 1 has an illuminating device 3. The illuminating device 3 comprises at least one light-emitting diode chip 20 (see also FIG. 5 in this respect). At least one optical element 4 can be arranged upstream and/or downstream of the illuminating device 3 in the main emission direction of the light-emitting diode chips 20. The optical element 4 is, for example, a reflector and/or a projection lens. The illuminating device 3 is thermally connected to a heat pipe 5. The illuminating device 3 is preferably thermally coupled to the heat pipe 5 by way of its evaporation region 6.

The heat pipe 5 dissipates at least some of the heat produced during operation by the illuminating device 3. Heat absorbed at the illuminating device 3 is output in the condensation region 7 of the heat pipe 5 to the surrounding area. To this end, the heat pipe 5 is connected in the condensation region 7 to a heat sink 8. The heat sink 8 is preferably located in the direct vicinity of a cover plate 10 of the motor vehicle headlight 1. The heat sink 8 preferably extends over a length of at least 50%, preferably 75%, of the length of the motor vehicle headlight along the motor vehicle headlight 1 in the horizontal direction.

The motor vehicle headlight is a closed system from which the power loss of the illuminating device 3 of typically approximately 50 Watts can only be dissipated by means of heat conductance or heat radiation. Venting slits with or without fans are not desired on account of dirt and condensation water. The engine space which is generally located near the motor vehicle headlight 1 produces, under unfavorable conditions, an ambient temperature of approximately 90° Celsius for the rear part of the motor vehicle headlight, in which the illuminating device 3 is also located. The power loss of the illuminating device 3 is guided away from the illuminating device 3 by means of the heat pipe 5. This makes it advantageously possible to dispense with moving components, such as fans. This increases the reliability of the headlight system.

The heat pipe 5 extends from the illuminating device 3 up to the front part of the motor vehicle headlight 1, i.e. preferably up to the cover plate 10 of the motor vehicle headlight 1, and preferably runs along the entire cover plate 10 or at least along 75% of the length of the cover plate in the lower part of the motor vehicle headlight 1. The lost heat absorbed at the illuminating device 3 is distributed to the air space directly at the inside of the cover plate 10 by way of the heat sink 8 which is connected to the heat pipe 5 in the region of the condensation region 7 of said heat pipe. From there, the heat can be dissipated to the surrounding area by way of free convection and heat conductance via the cover plate 10. During operation of the illuminating device 3, with the engine running, the temperature in the region of the illuminating device 3 is up to approximately 150° Celsius. The temperature in the front internal region of the motor vehicle headlight 1, at the cover plate 10 of the motor vehicle headlight, is—depending on the external temperature and running time of the engine—at most approximately 60° Celsius. The temperature on the outside of the cover plate 10 is—depending on the external temperature and running time of the engine—at most approximately 40° C. The large temperature gradient between illuminating device 3 and the air space in the front part of the motor vehicle headlight 1 assists the heat transport through the heat pipe 5 in an optimum fashion.

FIG. 2 illustrates the headlight 1 according to a second exemplary embodiment in a schematic side view Complementing the headlight 1 described in connection with FIG. 1, the heat pipe 5 is connected in its evaporation region 8 to a heat conducting element 9 in a thermally conducting manner. Alternatively to the heat pipe 5, it is also possible to use a thermosiphon or a loop thermosiphon in the exemplary embodiments of the motor vehicle headlight 1 described in connection with FIGS. 1 and 2.

FIG. 3 shows the heat pipe 5 and the heat conducting element 9 in a schematic detail view. The heat pipe 5 is soldered, for example, to the heat conducting element 9 in the evaporation region 6. It is furthermore possible for the heat pipe 5 to be embedded in the heat conducting element 9 in the evaporation region 6. In this case, the heat conducting element 9 encloses the heat pipe 5 in this region on at least three sides. The heat conducting element 9 consists of or contains a material which conducts heat well, such as copper or aluminum. The heat conducting element 9 is connected to the illuminating device 3 in a thermally conducting manner by way of its side which faces away from the heat pipe 5. Alternatively, the heat pipe 5 can also be connected directly to a connection mount 28 (see also FIG. 5 in this respect) of the illuminating device 3. In any case, the heat pipe is preferably thermally coupled to an underside of the illuminating device 3, which underside faces away from the light-emitting diode chips 20 of the illuminating device 3.

FIG. 4 illustrates a schematic detail view of the heat pipe 5 with heat sink 8. The heat sink 8 is connected in the condensation region 7 of the heat pipe 5 to said heat pipe. In the condensation region 7, the heat pipe 5 is embedded in the heat sink 8 or soldered to the heat sink 8. It is furthermore possible for the heat pipe 5 and the heat sink 8 to form one unit and to be designed in one piece. The heat sink 8 contains or consists of a material which conducts heat well, such as aluminum or copper. In order to increase its surface area, the heat sink 8 may comprise cooling structures 11, which may be in the form of a comb or of cooling fins, for example.

FIG. 5 shows a schematic perspective representation of an illuminating device as can be used in one of the motor vehicle headlights described herein. The illuminating device 3 comprises light-emitting diode chips 20 which are preferably suitable for producing white light. The light-emitting diode chips 20 are mounted in a housing 22 which may consist for example of a ceramic material such as aluminum nitrite. The light-emitting diode chips 20 can, however, also be mounted directly on the connection mount 28.

An inclined housing wall 21 is arranged downstream of the light-emitting diode chips 20 in the emission direction, which housing wall can be reflective and thus contributes to the beam shaping of the electromagnetic radiation produced. Through apertures in the housing 22, the light-emitting diodes 20 are connected in an electrically conducting manner via contact points 23 to conductor tracks 24 of the connection mount 28.

The illuminating device 3 can furthermore have components 25 which are suitable, for example, for protecting the light-emitting diode chips 20 against electrostatic discharge. To this end, for example a varistor, a diode or a resistor can be used. A power supply, which supplies power necessary for the operation to the illuminating device 3 by means of the contact points 27, can be connected to a mating plug 26.

The connection mount 28 is preferably formed by a metal core circuit board which can contain, for example, copper, aluminum and/or a ceramic material. Heat produced by the light-emitting diode chips 20 during operation is guided to the underside of the connection mount 28, which underside faces away from the light-emitting diode chips 20, and is absorbed from there either directly by the heat pipe 5 or by the heat pipe 5 via the heat conducting element 9.

FIG. 6 shows a principle schematic of a motor vehicle headlight according to a third exemplary embodiment. Unlike the first exemplary embodiment of the motor vehicle headlight described in connection with FIG. 1, the motor vehicle headlight has in this exemplary embodiment a loop thermosiphon 35 which dissipates at least some of the heat produced by the illuminating device 3 during operation. The thermosiphon 35 comprises a heat conducting element 9 which is in the form of a basebody filled with a coolant 36. The heat conducting element 9 forms the evaporation region 6 of the thermosiphon 35. Vapor is dissipated from the heat conducting element 9 toward the heat sink 8 in the direction of the arrow 37. The heat sink 8 comprises cooling structures 11 which are in the form of cooling fins, for example. The vapor condensates, at the heat sink 8, to form condensate 38 which is transported to the heat conducting element 9 in the direction of the arrow 39. The heat sink 8 is preferably arranged on the underside of the cover plate 10 of the motor vehicle headlight.

In the case of the loop thermosiphon 35 illustrated in FIG. 6, the heat conducting element 9 has both an opening for the extraction of the vapor and also an opening for the back-transport of the condensate 38. Alternatively, a simple thermosiphon can also be used, in which the heat conducting element 9 has a single opening through which vapor and condensate are transported in opposing directions.

In the case of a loop thermosiphon 35 or of a simple thermosiphon, the pipes of the thermosiphon are designed in one piece with the heat conducting element 9.

In the exemplary embodiment of the motor vehicle headlight 1 described in connection with FIG. 6, the heat sink 8 also preferably extends over a length of at least 50 per cent, preferably at least 75 per cent, of the length of the motor vehicle headlight along the motor vehicle headlight 1 in the horizontal direction.

The motor vehicle headlight 1 described herein is distinguished by a particularly high reliability since moving components, such as fans for cooling, can be dispensed with. Furthermore, the cooling apparatus comprising the heat pipe 5 or the thermosiphon 35 and the heat sink 8 can be installed particularly easily. Furthermore, the described motor vehicle headlight 1 is distinguished by particularly rapid thawing on the entire cover plate if the cover plate is iced up.

The above explanation of the invention with reference to the exemplary embodiments should not be understood to be a restriction of the invention to the exemplary embodiments. For example, the invention is in no way restricted to motor vehicle headlights, but encompasses all conceivable types of headlights. Features which have been explained using different exemplary embodiments can be combined with one another in any desired manner independently of the exemplary embodiment. The invention encompasses every novel feature, as well as every combination of features, which includes in particular every combination of features in the patent claims, even if those features or those combinations are not themselves mentioned explicitly in the patent claims or in the exemplary embodiments.

1. A motor vehicle headlight, comprising:
an illuminating device which comprises at least one light-emitting diode chip; and
a heat pipe or a thermosiphon with an evaporation region and a condensation region,
wherein the evaporation region is thermally connected to the illuminating device, and
wherein the condensation region is connected to a heat sink which outputs heat absorbed at the illuminating device to the surrounding area.

2. The motor vehicle headlight as claimed in claim 1, wherein the heat sink has a cooling structure.

3. The motor vehicle headlight as claimed in claim 1, wherein the evaporation region is thermally connected to the underside of the illuminating device, which underside faces away from the main emission direction of the light-emitting diode chip.

4. The motor vehicle headlight as claimed in claim 1, wherein the evaporation region is connected to a heat conducting element which is thermally connected to the illuminating device.

5. The motor vehicle headlight as claimed in claim 1, wherein the heat sink outputs the absorbed heat to a cover plate of the headlight.

6. The motor vehicle headlight as claimed claim 5, wherein the heat sink extends over at least 50% of the length of the cover plate.

7. The motor vehicle headlight as claimed in claim 5, wherein the absorbed heat is used to heat the cover plate.

8. The motor vehicle headlight as claimed in claim 5, wherein the absorbed heat is used to de-ice the cover plate.
